(19) United States
(12) Patent Application Publication
(10) Pub. No.: US 2010/0069194 A1
(43) Pub. Date: Mar. 18, 2010

(54) BICYCLE SPEED SHIFTING STRUCTURE

(75) Inventor: Wei-Yu Cheng, Yuanlin Chang Hua (TW)

Correspondence Address: RABIN & Berdo, PC, 1101 14TH STREET, NW, SUITE 500, WASHINGTON, DC, 20005, US

(73) Assignee: WHOLE SECURE INDUSTRIAL CO., LTD., Yuanlin Chang Hua (TW)

(21) Appl. No.: 12/233,067

(22) Filed: Sep. 18, 2008

(51) Int. Cl. F16H 3/44

(52) U.S. Cl. 475/269

(57) ABSTRACT

A bicycle speed shifting structure includes a link device, a driving device, a spring, a pedal shaft and a combining device installed inside a 5-way pipe of a bike body, and a sprocket installed outside the 5-way pipe for linking the sheathing device, and a disc, a sun gear, planetary gears, ring gears, outer gears, and a turning disc installed in an external casing and a chassis. If a pedal of the assembled structure is peddled, a pedal shaft will drive the turning disc to drive the ring gear and the outer gear to move in the same direction through rollers disposed on the periphery of the turning disc, so as to accelerate the bicycle and eliminate intermittent idle pedaling while shifting speed in a conventional structure, and the invention can be used for the speed shifting of various different models of bicycles.

### BACKGROUND OF THE INVENTION

1. Field of the Invention

The present invention relates to a bicycle structure, and more particularly to a bicycle speed shifting structure.

2. Description of the Related Art

In general, a front speed shifter installed above a pedal of a bicycle is exposed and mounted onto a front sprocket, such that a bicycle rider can control the front speed shifting of the front speed shifter manually to drive the speed shifting wire of the front speed shifter to guide a chain to move in sprockets with different number of teeth, so as to achieve the front speed shifting effect. However, such arrangement will produce intermittent idle pedaling when the front speed shifter guides the chain to move, and it is necessary to install the front speed shifter according to each different model. Thus, the prior art causes tremendous inconvenience to manufacturers.

In view of the shortcomings of the prior art, the inventor of the present invention developed a bicycle shifting structure in accordance with the present invention.

### SUMMARY OF THE INVENTION

Therefore, it is a primary objective of the invention is to overcome the shortcomings of the prior art by providing a bicycle speed shifting structure that adopts rollers disposed at the periphery of the turning disc to drive the ring gear and the outer gear to move in a same speed. If the speed shifting rod is operated, the driving device will be driven to move in a horizontal direction, such that the sun gear is engaged by the driving device and situated at a still condition, and the plurality of planetary gears disposed at the periphery of the sun gear accelerate its speed and operates together with the circular concave portion at the periphery of the turning disc to move unidirectionally downward, such that the ring gear and outer gear is rotated in a speed faster than the speed of the pedal shaft originally driven by the turning disc, so as to expedite the speed of the bicycle and achieve the speed shifting effect. The invention can be applied for the front speed shifting design of different models of bicycles.

To achieve the foregoing objective, the present invention provides a bicycle speed shifting structure comprising a link device, a driving device, a spring, a pedal shaft, and a combining device, installed inside a 5-way pipe of a bike body, and a sprocket installed outside the 5-way pipe for driving a sheathing device inside an external casing and a chassis composed of a disc, a sun gear, a plurality of planetary gears, a ring gear, an outer gear, and a turning disc, characterized in that a plurality of circular concave portions are disposed at the periphery of the turning disc for placing a roller in a single direction, and the roller is restricted in a rolling stand assembly, and situated in the circular concave portion of the turning disc and a circular groove of the ring gear.

The driving device and the pedal shaft are installed inside the 5-way pipe of the bike body, and a sprocket installed outside the 5-way pipe for driving the disc, the sun gear, the rolling bearing, the plurality of planetary gear, the ring gear, the outer gear and the turning disc in the sheathing device, characterized in that:

the pedal shaft is penetrated through the driving device, the spring, the combining device, the link device, the chassis, the external casing, the disc, the sun gear, the ring gear, the outer gear, and a center hole of the turning disc, and passed through the gear teeth for engaging the central internal gear teeth of the turning disc;

the driving device and the spring are disposed between two combining devices of the 5-way pipe, and a wavy sheathing serrated portion is disposed at a side of the driving device, and external screw threads of the two combining devices are screwed with internal screw threads on both sides of the 5-way pipe respectively, and its distal surface has a wavy engaging portion corresponding to a wavy engaging portion formed on a distal surface of the driving device;

the chassis, the disc and the sun gear are disposed at an edge on another side of the 5-way pipe, and the ring gear is installed at a side of the outer gear, wherein the sun gear is substantially T-shaped, and external gear teeth are disposed at the circumference of a circle with a larger diameter and engaged with equidistant internal gear teeth of the plurality of planetary gears and ring gears, and the disc and the outer gear are assembled from both sides, and combined and fixed with the disc through the turning disc; and

the turning disc and the external casing are disposed on another side of the outer gear, and gear teeth of the pedal shaft is engaged with central internal gear teeth of the turning disc, and one of its sides is passed through the shaft and integrally coupled with the plurality of planetary gears, ring gears and outer gears and the external casing as a whole.

The present invention provides a bicycle speed shifting structure, wherein the driving device is linked by a link device driven by a speed shifting rod to move in a horizontal direction, and engaged with the sun gear, such that the sun gear no longer rotates but remains still, and the plurality of planetary gears rotated at the periphery of the sun gear are rotated more quickly to drive the ring gears and outer gears to exceed their original rotating speeds. The advantages of the invention includes eliminating the idle pedaling occurred in the prior art during the process of shifting speed, and completing the speed shifting effect without any intermittent idle pedaling.

In the present invention, the base 12 includes a control circuit component and a battery module (not shown in the figure), and the control circuit component and the battery module are prior arts, and thus will not be described here.

### BRIEF DESCRIPTION OF THE DRAWINGS

FIG. 1 is a perspective view of an installation position of the present invention;

FIG. 2 is an exploded view of the present invention;

FIG. 3 is a first schematic view of an assembled bicycle before changing speed in accordance with the present invention;

FIG. 4 is a second schematic view of an assembled bicycle before changing speed in accordance with the present invention;

FIG. 5 is a third schematic view of an assembled bicycle before changing speed in accordance with the present invention;

FIG. 6 is a fourth schematic view of an assembled bicycle after changing speed in accordance with the present invention;

FIG. 7 is a first schematic view of an assembled bicycle after changing speed in accordance with the present invention;

FIG. 8 is a second schematic view of an assembled bicycle after changing speed in accordance with the present invention;

FIG. 9 is a third schematic view of an assembled bicycle after changing speed in accordance with the present invention; and

FIG. 10 is a fourth schematic view of an assembled bicycle after changing speed in accordance with the present invention.

### DETAILED DESCRIPTION OF THE PREFERRED EMBODIMENTS

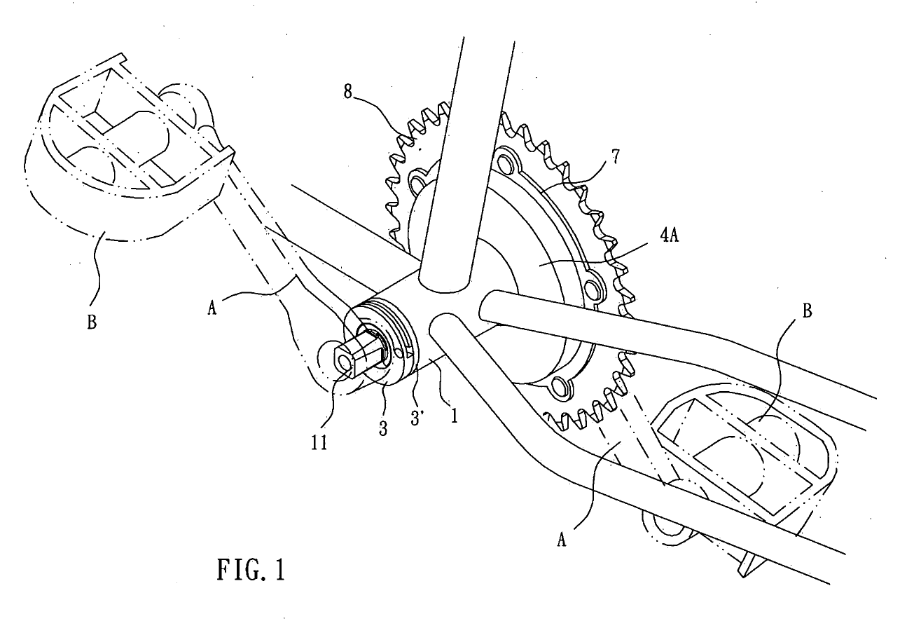

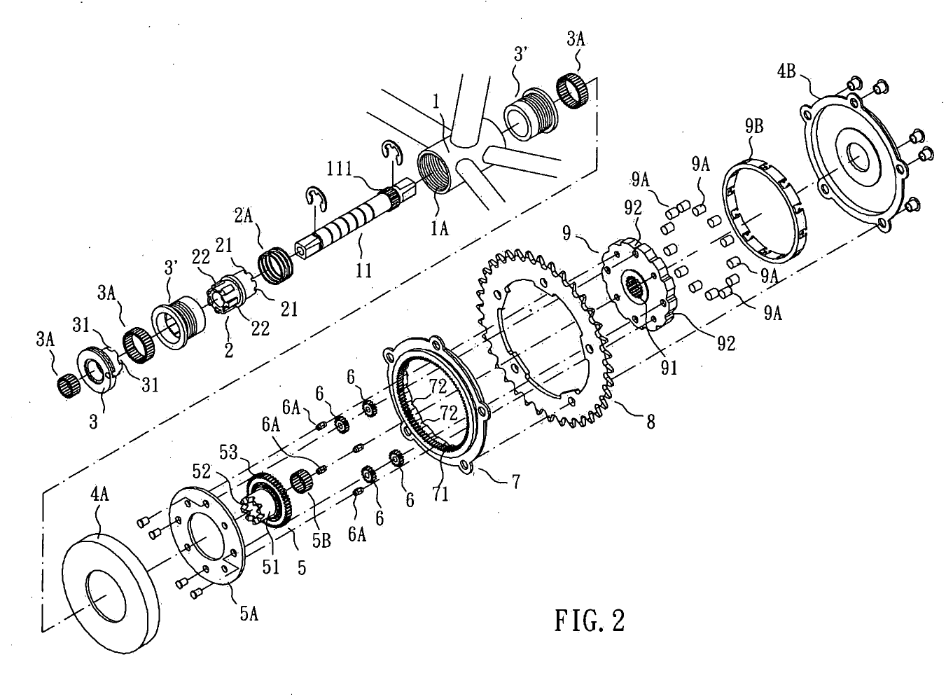

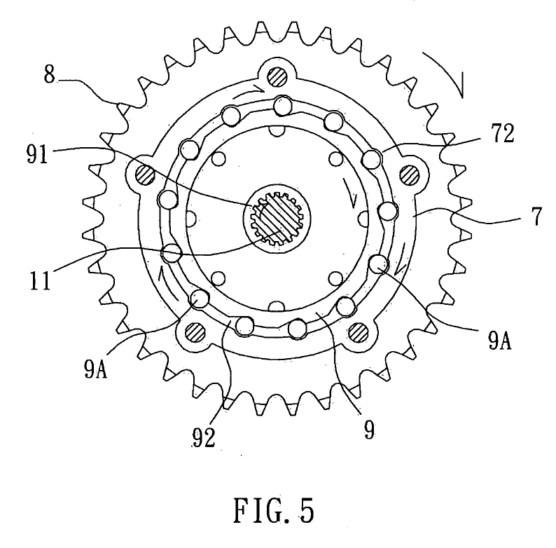

With reference to FIGS. 1 and 2 for a bicycle speed shifting structure, the structure comprises a pedal shaft 11, a driving device 2 and a spring 2A installed inside a 5-way pipe 1 of a bike body, a combining device 3′ and a rolling bearing 3A installed on each of the both sides of the bike body, a link device 3 and a rolling bearing 3A installed on the utmost outer side of the bike body, and a sprocket exploded from a side of the 5-way pipe 1 for driving a sheathing device inside a chassis 4A and an external casing 4B composed of a disc 5A, a sun gear 5, a rolling bearing 5B, a plurality of planetary gear 6, a ring gear 7, an outer gear 8 and a turning disc 9, wherein the pedal shaft 11 is penetrated at the driving device 2, the spring 2A, the combining device 3′, the rolling bearing 3A, the link device 3, the chassis 4A, the external casing 4B, the disc 5A, the sun gear 5, the rolling bearing 5B, the ring gear 7, the outer gear 8, and a center hole of the turning disc 9 and passed through a gear teeth 111 to engage internal gear teeth 91 of the turning disc 9. The driving device 2 and spring 2A are disposed between two combining devices 3′ of the 5-way pipe 1, and a wavy sheathing serrated portion 21 is disposed at a side of the driving device 2 and screwed with internal screw threads on both sides of the 5-way pipe 1 by the external screw thread of the two combining devices 3′. After the link device 3 driven by a guide wire of the speed shifting rod is rotated, the wavy engaging portion 31 passing through a distal surface of the link device is used for pushing a distal surface of the driving device 2 to move the wavy engaging portion 22 in a horizontal direction, and determine whether or not to engage with a serrated portion 52 at a distal end of the cylindrical body 51 of the sun gear 5. The chassis 4A, the disc 5A, the sun gear 5, the rolling bearing 5B, the plurality of planetary gears 6 and ring gears 7 are disposed on another side of the 5-way pipe 1 and installed at a side of the outer gear 8, and the turning disc 9 and the external casing 4B are disposed at another side of the outer gear 8, wherein the sun gear 5 is substantially T-shaped, and external gear teeth 53 are disposed at a circumference with a larger diameter. After the external gear teeth 53 are engaged with equidistant internal gear teeth 71 of the plurality of planetary gears 6 and ring gears 7, the disc 5A and the outer gear 8 are attached from both sides, and then the turning disc 9 is coupled and fixed with the disc 5A. The ring gear 7, the outer gear 8 and the external casing 4B are integrated as a whole, and the turning disc 9 includes a plurality of circular concave portions 92 disposed at the periphery of the turning disc 9 for placing the roller 9A. After a rolling stand 9B is assembled and restricted, the roller 9A disposed in the circular concave portion 92 at the periphery of the turning disc 9 and the circular groove 72 of the ring gear 7 for rotating the ring gear 7 while the turning disc 9 is rotating, and the central internal gear teeth 91 is provided for engaging the gear teeth 111 of the pedal shaft 11 (as shown in FIG. 5), and pivotally coupled to the plurality of planetary gears 6 from the shaft 6A.

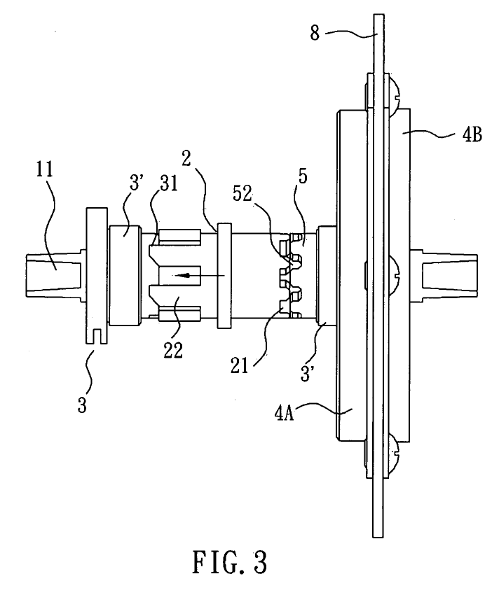

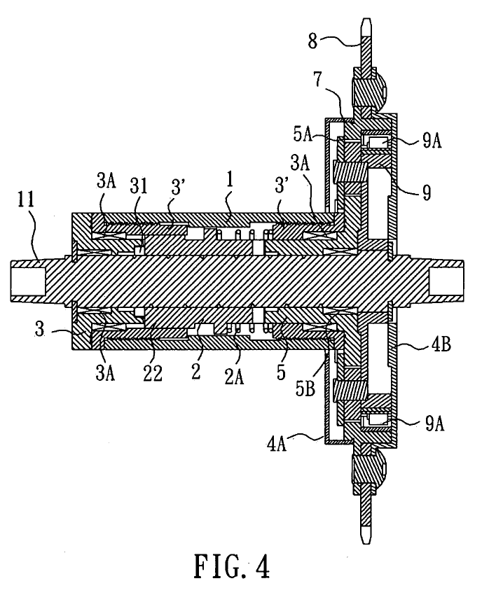

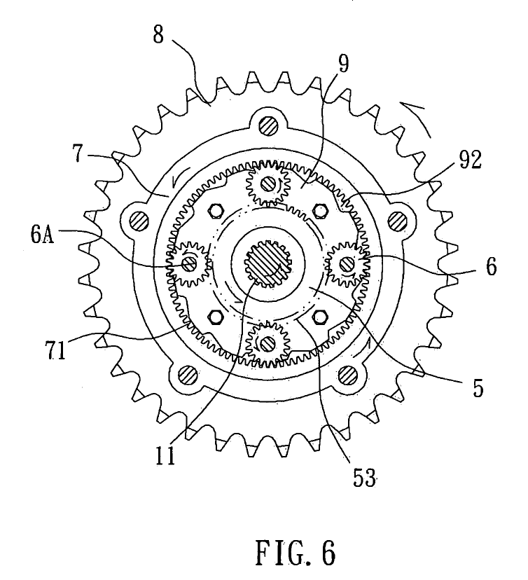

After the pedal shaft 11, the crank A and the pedal B protruded from both sides are assembled, and before the rider operates the speed shifting rod for pedaling (as shown in FIGS. 3 and 4), the pedal shaft 11 drives the turning disc 9 to turn synchronously. With the circular concave portions designed at the periphry of the turning disc 9 for a unidirectional drive, the roller 9A installed at the periphery of the turning disc 9 is used to drive the ring gear 7 to move (as shown in FIG. 5), so that the ring gear 7 and the outer gear 8 are rotated at the same speed of the pedal shaft 11 and the turning disc 9, and the planetary gear 6 engaged with the internal gear teeth 71 of the ring gear 7 is moved around a circle, and the sun gear 5 engaged with the planetary gear 6 is rotated accordingly (as shown in FIG. 6). Since the sun gear 5 is not connected to the driving device 2, the sun gear 5 will be in the condition of an idle rotation, and thus will not affect the outer gear 8 driven the pedal shaft 11, so that both of them have a constant rotating speed.

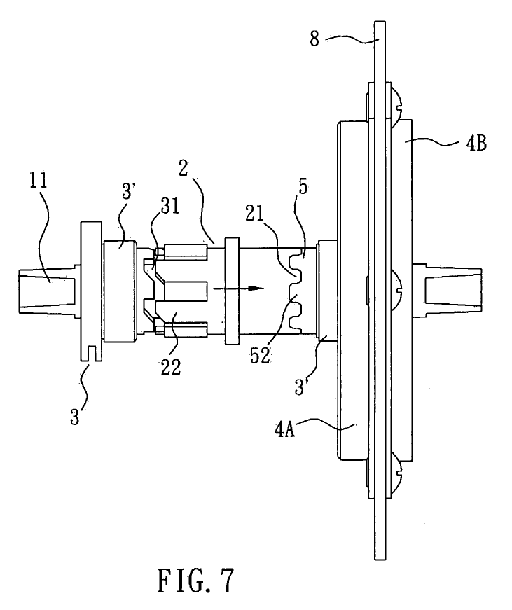

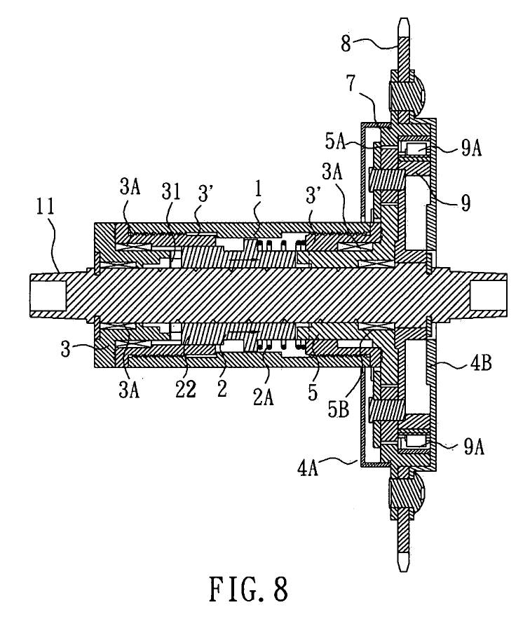

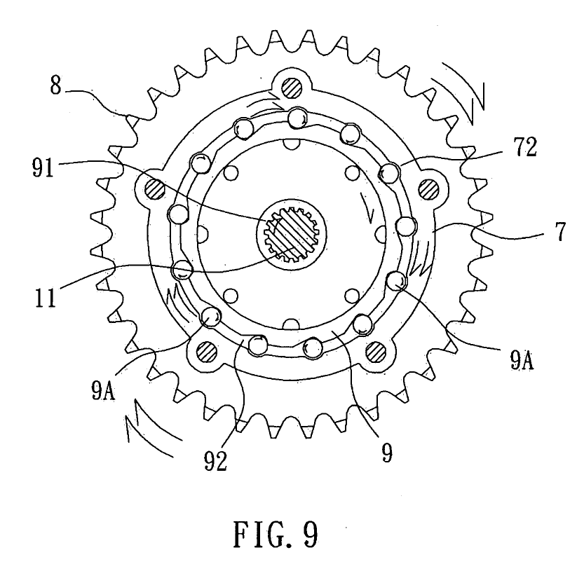

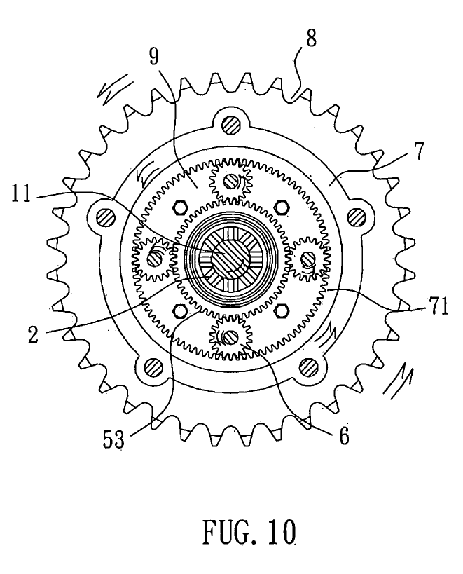

If the rider operates the speed shifting rod while the pedal shaft 11 is still driving the turning disc 9 to rotated at a constant speed. In other words, after the speed shifting rod is rotated by the guide wire of the link device 3, the wavy engaging portion 31 formed at the distal end is used for pushing the distal surface of the driving device 2 to move the wavy engaging portion 22 in a horizontal direction, such that the sheathing serrated portion 21 of the driving device 2 is sheathed with the serrated portion 52 at a distal end of the cylindrical body 51 of the sun gear 5 for an engagement operation (as shown in FIGS. 7 and 8), and the sun gear 5 is idle and no longer rotated. Under the principle of planetary rotation as shown in (FIG. 10), the rotating speed of the plurality of planetary gears 6 driven by external gear teeth 53 of the sun gear 5 is increased to exceed the original speed. In the meantime, the ring gear 7 and the outer gear 8 are driving to rotate faster than the rotating speed of the turning disc 9 driven by the pedal shaft 11. With the unidirectional driving design of the circular concave portion 92 at the periphery of the turning disc 9 driven by the pedal shaft 11 (as shown in FIG. 5), the roller 9A is rotated to eliminate the difference of rotating speeds of the ring gear 7 and the outer gear 8 and the turning disc 9 (as shown in FIG. 9) when the rotating speed of the ring gear 7 and the outer gear 8 exceeds the rotating speed of the turning disc 9, so as to achieve a fast rotation. The constant rotating speed produced by the original operation of rotating the outer gear 8 by the pedal shaft 11 is changed to a situation that the driving device 2 is displaced to increase the rotating speed of the outer gear 8 to a speed greater the rotating speed of the pedal shaft 11 (which is a shift of speed), so as to achieve the effect of increasing the riding speed of the bicycle.

Since the speed shifting of the invention is achieved by using the displacement of the driving device 2 to drive the sun gear 5 to move the plurality of planetary gears 6 at the periphery of the sun gear 5, and change the speed of the ring gear 7 and the outer gear 8 immediately, and thus the present invention will not produce an idle pedaling during the process of shifting speed.

In summation of the description above, the present invention improves over the prior art, and complies with the requirements of patent application, and thus is duly filed for patent application.

What is claimed is:

1. A bicycle speed shifting structure, comprising a link device, a driving device, a spring, a pedal shaft, and a combining device, installed inside a 5-way pipe of a bike body, and a sprocket installed outside the 5-way pipe for driving a sheathing device inside an external casing and a chassis composed of a disc, a sun gear, a plurality of planetary gears, a ring gear, an outer gear, and a turning disc, characterized in that a plurality of circular concave portions are disposed at the periphery of the turning disc for placing a roller in a single direction, and the roller is restricted in a rolling stand assembly, and situated in the circular concave portion of the turning disc and a circular groove of the ring gear.

2. The bicycle speed shifting structure of claim 1, wherein the driving device and the pedal shaft installed inside the 5-way pipe of the bike body and the sprocket installed outside the 5-way pipe for driving the disc, the sun gear, the rolling bearing, the plurality of planetary gears, the ring gear, the outer gear, the turning disc in the sheathing device are respectively disposed at:
a pedal shaft, penetrating into the driving device, the spring, the combining device, the link device, the chassis, the external casing, the disc, the sun gear, the ring gear, the outer gear and a center hole of the turning disc, and passed through gear teeth and engaged with the central internal gear teeth of the turning disc;
a driving device and a spring, situated between two combining devices in the 5-way pipe, and the driving device having a wavy sheathing serrated portion disposed on a side of the driving device, an external screw thread of the two combining devices being screwed with an internal screw thread disposed separately on both sides of the 5-way pipe, and having a wavy engaging portion disposed on a distal surface and corresponding to the wavy engaging portion formed on the distal surface of the driving device;
the chassis, the disc, the sun gear, and the ring gear disposed on another side of the 5-way pipe being installed on a side of the outer gear, wherein the sun gear is substantially T-shaped and includes external gear teeth disposed on the circumference of a larger diameter, and engaged with and the equidistant internal gear teeth of the plurality of planetary gears and ring gears with, and the disc and the outer gear are combined by both sides and coupled and positioned by the turning disc and the disc;
the turning disc, external casing, disposed on another side of the outer gear, and the gear teeth of the pedal shaft being sheathed with central internal gear teeth of the turning disc, and the plurality of planetary gears, ring gears and outer gears disposed on one of the sides being passed through the shaft and pivotally coupled with the external casing as a whole.
